(19) United States
(12) Patent Application Publication
(10) Pub. No.: US 2004/0167793 A1
(43) Pub. Date: Aug. 26, 2004

(54) Network monitoring method for information system, operational risk evaluation method, service business performing method, and insurance business managing method

(76) Inventors: Yoshimasa Masuoka, Fuchu (JP); Ken Naono, Tachikawa (JP); Shin Kameyama, Kodaira (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/629,920

(22) Filed: Jul. 30, 2003

(30) Foreign Application Priority Data
Feb. 26, 2003 (JP) 2003-048456

(51) Int. Cl. G06F 17/60

(52) U.S. Cl. 705/1; 705/35

(57) ABSTRACT

There is provided a method which can check whether or not internal data for operational risk evaluation of a business organization is collected from all computers in the business organization. In application execution servers, one or more agent for collecting loss events occurring in the computers is arranged. One or more network monitoring server connected to a network of the business organization is arranged. The network monitoring server monitors the network. When the application execution servers include a computer having no agent, the network monitoring server adds the presence of the computer having no agent to a monitoring log to make it possible to check whether the agents for collecting internal data is arranged in all computers for executing an application in the business organization. Therefore, an operational risk can be faithfully evaluated.

### TECHNICAL FIELD OF THE INVENTION

The present invention relates to a network monitoring method, an operational risk evaluation method, and the like and, more particularly, to a technique which is effectively applied to an operational risk evaluation technique for an information processing system including a plurality of computers using a network.

### BACKGROUND OF THE INVENTION

As described in a reference “Working Paper on the Regulatory Treatment of Operational Risk” (Basel Committee on Banking Supervision), Bank for International Settlements, September, 2001), in recent years, business organizations (including nonprofit organizations and general organizations which are generically called “business organizations”) try to measure amounts of loss caused by operational mistakes of the internal information system and faults or the like occurring in the information system as one risk management method for maintaining the soundness of the business organizations. A risk of this type is called an operational risk, and is especially important in banking facilities. Events which are decided as operational risks and classifications of events corresponding to operational risks are defined at the present as described in the above reference.

According to Reference “All of Operational Risk” (Society for the Study of Operational Risk of Mitsubishi Trust And Banking Corporation, TOYO KEIZAI INC., March, 2002, pp. 108 to 112, pp. 133 to 134), an operational risk can be evaluated by, e.g., the following method. That is, past internal and external date of a business organization are collected and accumulated, and data (to be referred to as operational loss events hereinafter) serving as a source representing events in which losses are generated are collected. A predetermined evaluation is performed to the collected loss events to evaluate an operational risk.

In a present business organization, almost all business applications are executed by using an information system in one way or another. This information system generally executes business applications by using a plurality of computers (terminals, servers, and the like) connected to a network. For this reason, in collection of the loss events, it is important to obtain operation history information such as an error log in operation management functions of the information system. Operation management functions are described in the U.S. Pat. No. 5,948,055, the U.S. Pat. No. 5,787,252, and the like. In these operation management functions can monitor information flowing in the network so that a diagram of a configuration of computers and the like connected to the network can be formed.

### SUMMARY OF THE INVENTION

When the present inventors have studied the technique of operational risk evaluation described above, the following fact was apparent.

It is necessary to collect loss events in a business organization in order to evaluate an operational risk. However, in the conventional technique, the following point is posed as a problem to utilize risk management for an operational risk.

More specifically, there is no method for checking whether loss events are collected from all the computers used in a business application in the business organization or not. For this reason, it cannot be checked whether loss events collected in evaluation of an operational risk are all loss events occurring in the business organization or not or whether a range of error allowed for operational risk evaluation is sufficient or not.

For example, it is assumed that a loss is generated in the business organization by an operational mistake of a certain computer. If the computer is not subjected to information collection of loss events, the evaluated operational risk is evaluated as an unreasonably low risk. In this case, operational risks cannot be appropriately managed as a part of business management. In addition, it cannot be disclosed that operational risk management is appropriately performed.

It is the first object of the present invention to provide a network monitoring method which can check whether loss events are collected from all computers used in a business application in a business organization or not for operational risk evaluation.

It is the second object of the present invention to provide an operational risk evaluation method using the network monitoring method.

It is the third object of the present invention to provide a service method for operational risk evaluation using the network monitoring method.

The above objects, the other objects, and novel characteristic features will be apparent from the description of this specification and the accompanying drawings.

Outlines of typical aspects of the invention disclosed in this application will be briefly described below.

More specifically, in a network monitoring method and an operational risk evaluation method according to the present invention, in at least one first computer (application execution server), at least one agent for collecting loss events occurring in the computer is arranged. At least one second computer (network monitoring server), connected to a network of the business organization for executing an application, for monitoring the network is arranged. The second computer monitors the network and, if the first computers include a computer having no agent, records that the first computers include the computer having no agent.

As a method for causing the second computer to monitor the network, there is provided a method including the step of monitoring a packet flowing in the network, the step of extracting the address of a transmission source and/or transmission destination from the packet, the step of transmitting a message to the agent of the computer corresponding to the extracted address, and the step of checking a response to the transmitted message.

As another method for causing the second computer to monitor the network, there is provided a method including the step of, when the network is connected to a network device (such as router) which holds an address list of computers which repeat a packet, obtaining the address list such that the second computer communicates with the network device, the step of transmitting a message to the agent of the computer corresponding to an address in the address list, and the step of checking a response to the transmission message. In this case, since a packet need not be monitored, the number of steps can be reduced.

As an operational risk evaluation method, there is provided a method including the step of executing an agent for collecting loss events occurring in the first computer, the step of collecting an operation history in the first computer, the step of extracting an event in which a loss is generated from the operation history, the step of determining an amount of loss in the event, and the step of evaluating an operational risk.

Therefore, according to the network monitoring method and the operational risk evaluation method, not only evaluation of an operational risk on the basis of the loss events collected by the agent but also inspection of the record of the second computer are performed, so that it can be checked that loss events are collected from all the computers used in a business application in the business organization.

More specifically, if the record does not include a specific description, the agents are arranged in all the computers used in the business application in the business organization, and it can be checked that the loss events are collected from all the computers. If the record includes a specific description, a computer having no agent is inspected by a manual operation or an interview, and loss events can be collected from all the computers in the business organization.

Another service trader arranges the second computers in a business organization holding information systems and connects the network of the information systems of the business organization, so that a service which certifies the correctness of an operational risk of the business organization can be provided.

An insurance company or the like applies the operational risk evaluation method to information systems of a customer business organization, so that a loss generated by the event corresponding to the operational risk of the customer business organization can be correctly evaluated. Insurance business which compensates for the loss and determines an insurance fee on the basis of the evaluation result can be managed.

### BRIEF DESCRIPTIONS OF THE DRAWINGS

FIG. 1 is a diagram showing the hardware and software configurations of an information system according to an embodiment of the present invention.

FIG. 2 is a diagram showing the structure and contents of a packet in the embodiment of the present invention.

FIG. 3 is a flow chart showing an operational risk evaluation method which is executed in a system management server in the embodiment of the present invention.

FIG. 4 is a flow chart showing an operation of a detector of a network monitoring server in the embodiment of the present invention.

FIG. 5 is a diagram showing hardware and software configurations when an information system is constituted by a router and one or more subnetwork in the first modification of the embodiment of the present invention.

### DESCRIPTION OF THE PREFERRED EMBODIMENTS

Embodiments of the present invention will be described below with reference to the accompanying drawings. The same reference numerals as in all the drawings for explaining the embodiments denote the same parts in the drawings, and a description thereof will be omitted.

(Hardware Configuration)

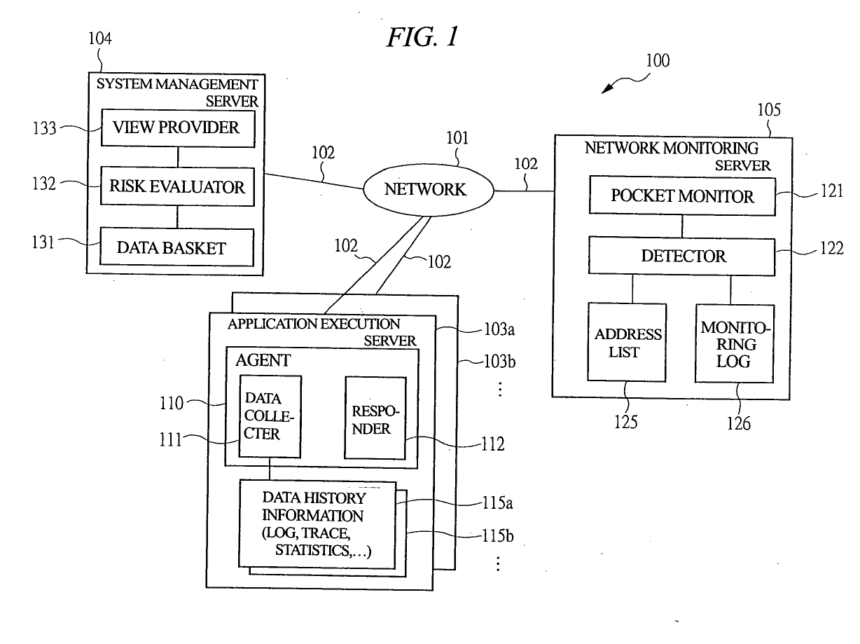

FIG. 1 is a diagram showing the hardware configuration of an information system according to an embodiment of the present invention. An information system 100 of a business organization in this embodiment has a network 101. The network 101 connects computers in the business organization through a link 102. The link 102 may use a cable system or a wireless system. Although not shown in FIG. 1, the network 101 may have a link for communicating with a computer set outside the business organization may have a link for communicating with a computer set outside the business organization.

The information system 100 has computers of three types. More specifically, the computers include application execution servers (first computers) 103a, 103b, . . . , a system management server 104, and a network monitoring server (second computer) 105.

As the concrete examples of the application execution servers 103a, 103b, . . . , terminals, personal computers, server computers, main frames, network devices, and the like are used. The computers are connected to the network 101 and separately execute a business application of the business organization having the information system 100 while communicating with the application execution servers 103a, 103b, . . . as needed. Although not shown in FIG. 1, the application execution servers 103a, 103b, . . . have one or more processor, one or more storage device, and one or more network interface. Each of the application execution servers 103a, 103b, . . . may have a magnetic disk or an external storage device depending on the use of the corresponding application execution server. The magnetic disk and the external storage device are not shown in FIG. 1.

Although only one system management server 104 is shown in FIG. 1, a plurality of system management servers 104 may be arranged. The system management server 104 is connected to the network 101. The system management server 104 is a computer which collects loss events to evaluate an operational risk. Although not shown in FIG. 1, the system management server 104 has one or more processor, one or more storage device, and one or more network interface.

Although only one network monitoring server 105 is shown in FIG. 1, a plurality of network monitoring servers 105 may be arranged. The network monitoring server 105 is connected to the network 101. The network monitoring server 105 is a computer which monitors the network 101 to monitor and detect that a computer in which an agent 110 (will be described later) is not arranged is connected to the information system 100. Although not shown in FIG. 1, the network monitoring server 105 has one or more processor, one or more storage device, and one or more network interface.

In this embodiment, the application execution servers 103a, 103b, . . . , the system management server 104, and the network monitoring server 105 are handled as computers which are in different cases, respectively. However, in fact, all or two of the computers of three types may be stored in the same case.

(Software Configuration)

The software configuration, i.e., a configuration of a program and data, of this embodiment will be described below with reference to FIG. 1.

On the application execution servers 103a, 103b, . . . , the agent 110 is executed. The agent 110 is a program including a data collector 111 and a responder 112 and the processor of the application execution servers 103a, 103b, . . . execute the agent 110.

The data collector 111 loads the contents of data history information 115a, 115b, . . . in the application execution servers 103a, 103b, . . . at the predetermined intervals and transmits the contents to a data basket 131 of the system management server 104 through the network 101.

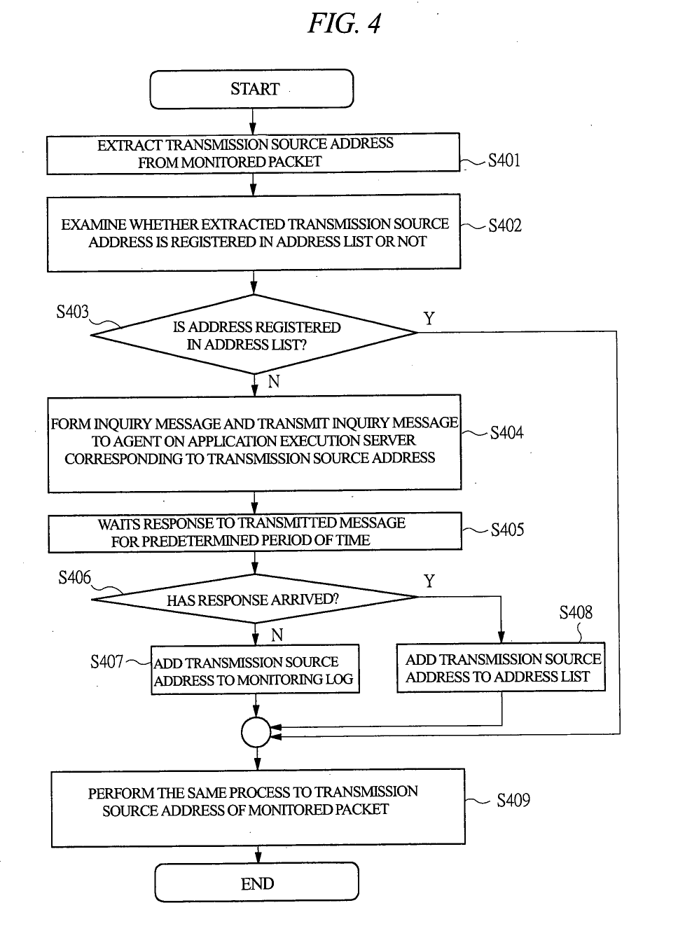

The responder 112 waits for an inquiry message sent from a detector 122 of the network monitoring server 105. When the inquiry message is sent, the responder 112 transmits a response message to the detector 122 serving as a transmission source. Although it will be described later by using FIG. 4, the detector 122 checks whether the agent 110 is executed on the application execution servers 103a, 103b, . . . by using the inquiry message.

Although not shown in FIG. 1, on the application execution servers 103a, 103b, . . . , not only the agent 110 but also one or more application program for performing a business application of a business organization are executed. The corresponding applications output a past log, an error message, trace information of execution progression, and operating statistic information to the data history information 115a, 115b, . . . , respectively. The data history information 115a, 115b, . . . can be referred as data of files on a magnetic disk, output results of operation commands, and the like by the data collector 111 of the agent 110.

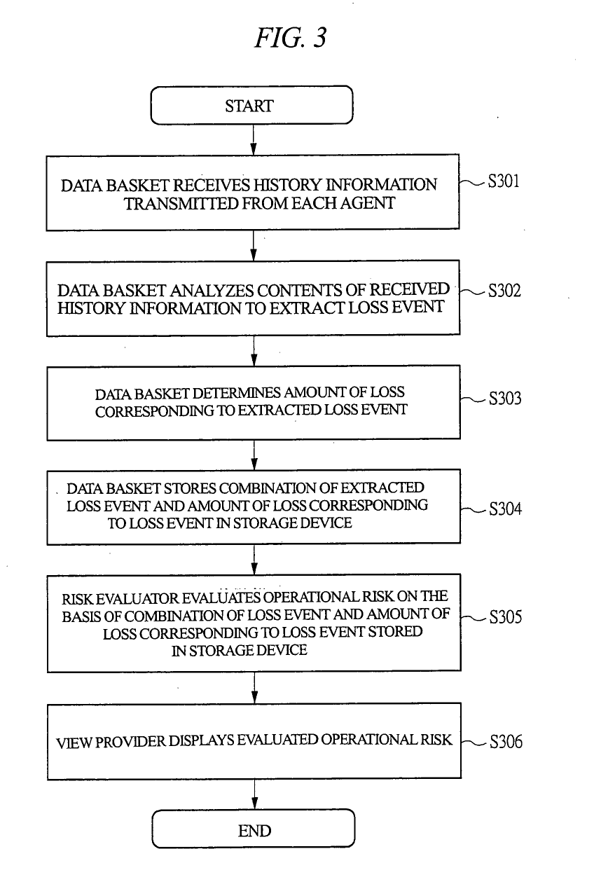

In the system management server 104, three programs are executed. More specifically, the programs correspond to a data basket 131, a risk evaluator 132, and a view provider 133. Although the operations of these programs will be described later with reference to FIG. 3, the data basket 131 totalizes the history information transmitted from the data collector 111 of the agent 110, the risk evaluator 132 evaluates an operational risk on the basis of the totalization result of the data basket 131, and the view provider 133 displays the evaluated operational risk. Another program may be executed by the system management server 104.

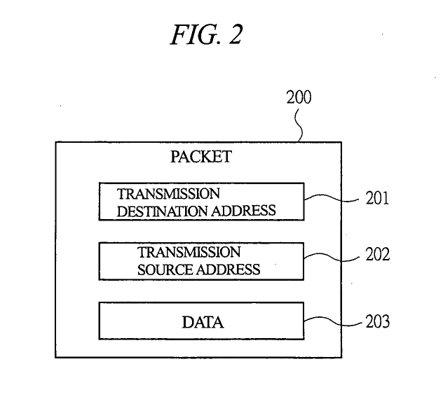

In the network monitoring server 105, two programs of the packet monitor 121 and the detector 122 are executed. The packet monitor 121 uses a network interface held by the network monitoring server 105 to monitor a packet flowing in the network 101. The structure and contents of the packet is shown in FIG. 2. The detector 122 receives the packet monitored by the packet monitor 121, extracts the address of a transmission source and the address of a transmission destination from the packet, and checks whether the agent 110 is executed on the application execution servers 103a, 103b, . . . to which the addresses are allocated or not. The detector 122 holds data of two types, i.e., the address list 125 and the monitoring log 126 for the above process. Although the address list 125 is generally stored in a main memory, the address list 125 may be stored on a magnetic disk. The monitoring log 126 is stored on a magnetic disk. The operation of the detector 122 will be described below with reference to FIG. 4.

Although not shown in FIG. 1, operating systems are loaded on the main memories of the computers and executed by the processors of the computers. Execution of the programs such as the agent 110 is managed by the operation systems. The respective programs send requests to the operating systems to perform network communication, access to a file or data on a magnetic disk, and the like.

In this embodiment, all of the agent 110, the data collector 111, and the responder 112 of the application execution servers 103a, 103b, . . . , the data basket 131, the risk evaluator 132, and the view provider 133 of the system management server 104, and the packet monitor 121 and the detector 122 of the network monitoring server 105 are handled as programs. However, things being other than programs and having the same functions as described above may be used.

(Network Communication)

As shown in FIG. 1, the network 101 connects the application execution servers 103a, 103b, . . . , the system management server 104, and the network monitoring server 105 to each other.

The connection to the network will be described below in detail. Each of the computers has a network interface (not shown in FIG. 1). The network interfaces are connected to the network 101 through the link 102.

Unique network addresses (to be referred to as “addresses” hereinafter) are allocated to the network interfaces, respectively. The addresses will realize communication between computers as follows. More specifically, a transmission side designates the address of a transmission destination and a region on a main memory which stores data to be sent and sends a command to the network interface of the transmission side, so that a packet 200 (FIG. 2) is transmitted through the network 101. The packet 200 is received by the network interface to which the address of the transmission destination is allocated, and is written in a region on the main memory designated by the receiving side. As shown in FIG. 2, the packet 200 includes a transmission destination address 201, a transmission source address 202, and data 203.

The details of a communication method which realizes the above function, i.e., “when unique addresses are allocated to the network interfaces, a transmission side designates the address of a transmission destination to correctly deliver data to be transmitted to a device having a network interface to which the designated address is allocated” are described in Reference “W. Richard Stevens, “UNIX (registered trademark) Network Programming”, Prentice-Hall, pp. 171-196”. In the information system of this embodiment, it is believed that the communication method has been established so that a more detailed description of the communication method will be omitted in this specification.

(Operational Risk Evaluation Method)

FIG. 3 shows an operational risk evaluation method according to this embodiment. In this embodiment, operational risk evaluation is performed by the data basket 131, the risk evaluator 132, and the view provider 133 of the system management server 104 in FIG. 1.

The data basket 131 receives history information transmitted from the agents 110 on the application execution servers 103a, 103b, . . . (step S301). The data basket 131 analyzes the contents of the received history information to decide whether the event corresponds to a loss event or the type of loss event, and extracts the loss event from the decision result (step S302). More specifically, in this decision, a method for inspecting whether an error message included in, e.g., the history information coincides with a registered character string pattern in advance or not, a method for displaying the contents of the history information on a proper display to urge a responsible person of the business organization who watches the display to select the corresponding loss event from selectable events to obtain the loss event, and the like are used.

The data basket 131 determines an amount of loss suffered by the business organization to the extracted loss event (step S303). More specifically, the following method or the like is used. For example, with respect to each extracted loss event, occurrence data and time, occurrence location, and the type of the loss event, are displayed on the display. A responsible person who watches the display refers to past accident reports to extract a report having the same occurrence date and time and the same occurrence location as those of the loss event, and inputs the amount of loss described in the report as an amount of less of the loss event.

The data basket 131 stores a combination of the extracted loss event and the amount of loss formed in the step S303 in the storage device of the system management server 104 (step S304).

The risk evaluator 132 evaluates an operational risk on the basis of combinations of loss events and amounts of loss stored in the storage device by the data basket 131 (step S305). As a more concrete evaluation method, for example, the method described in Reference “All of Operational Risk” (Society for the Study of Operational Risk of Mitsubishi Trust And Banking Corporation, TOYO KEIZAI INC., March, 2002, pp. 108 to 112, pp. 133 to 134) may be used. The risk evaluator 132 gives the evaluation result to the view provider 133.

The view provider 133 to which the evaluation result is given display the evaluation result on an output device such as a display, stores the evaluation result in a file in the storage device, or transmits the evaluation result to another computer through the network 101, so that the evaluation result can be used in risk management by the business organization (step S306).

(Method for Detecting Computer Having No Agent)

FIG. 4 shows a method for detecting whether a computer having no agent is connected to the network 101 of the information system 100 or not, in the present embodiment. This process is performed by the detector 122 of the network monitoring server 105.

The detector 122 extracts a transmission source address from a packet 200 (FIG. 2) given by the packet monitor 121 (step S401). The detector 122 refers to the address list 125 to examine whether the extracted transmission source address 202 is registered in the address list 125 or not (step S402). If the transmission source address 202 is registered in the address list 125, the detector 122 shifts to step S409 (step S403). If the transmission source address 202 is not registered in the address list 125, the detector 122 forms an inquiry message, the destination of which is set as the agent 110 on the computer corresponding to the transmission source address 202, and the detector 122 transmits the inquiry message to the network 101 (step S404).

In addition, the detector 122 waits for a predetermined period of time until a response to the transmitted inquiry message reaches the network monitoring server 105 (step S405). A specific waiting time may be set by a business organization. If the response reaches the network monitoring server 105 within the predetermined period of time (step S406), the transmission source address 202 extracted in step S401 is added to the address list 125 (step S408). If the response does not reach the network monitoring server 105, the transmission source address 202 extracted in step S401 is added to the monitoring log 126 (step S407). In step 407, for a later inspection, not only the transmission source address 202 but also present time, the contents of the packet, and the like may be added to the monitoring log 126. In step S407, a process of displaying a message on a terminal of a responsible person may be executed to cause the responsible person to immediately start an inspection. The detector 122 executes one of the processes in step S407 and step S408 and then shifts to step S409.

The detector 122 also executes the processes in steps S401 to S408 with respect to the transmission destination address 201 of the packet 200 (FIG. 2) given by the packet monitor (step S409).

With the above procedure, when the computer having no agent is connected to the network 101, the address of the computer can be recorded on the monitoring log 126 when the computer performs communication through the network 101. Therefore, the monitoring log 126 is inspected in operational risk evaluation, so that it can be checked whether loss events are extracted from all the computers used in a business application in the business organization or not.

More specifically, according to this embodiment, when the monitoring log 126 of the network monitoring server 105 does not include any description, the agents 110 are set in all the computers used in a business application in the business organization. It can be checked that the loss events are collected from all the computers. If the monitoring log 126 includes some description, a computer having no agent 110 and described in the monitoring log 126 is separately inspected by a manual operation or an interview, so that loss events can be collected from all the computers in the business organization.

(Modification of Network Monitoring Method)

In this embodiment, the packet 200 (FIG. 2) flowing in the network 101 is monitored by the packet monitor 121 of the network monitoring server 105 and given to the detector 122, so that a computer having no agent is detected. The two modifications will be described below.

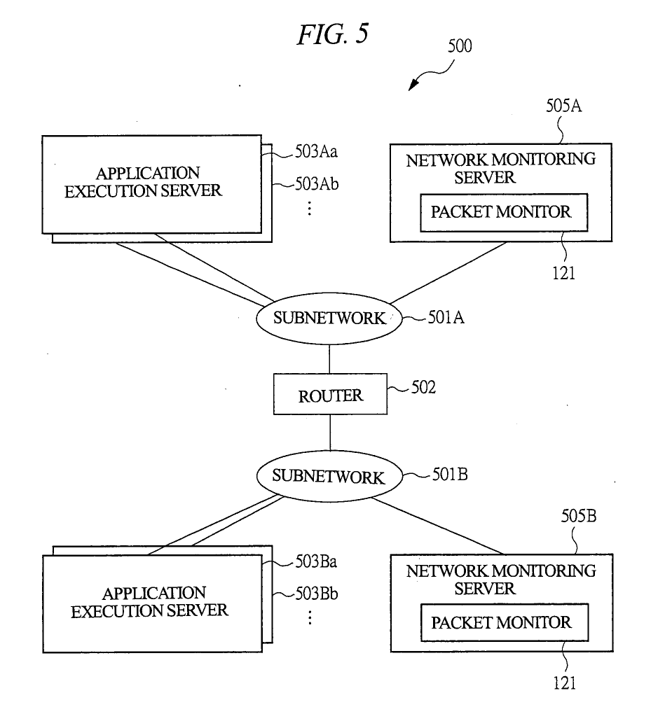

The first modification is used when a network of an information system is actually constituted by combinations of subnetworks. FIG. 5 is a diagram showing hardware and software configurations of the information system according to the first modification. In FIG. 5, computers of an information system 500 in a business organization are connected by two subnetworks 501A and 501B and network devices such as a router 502 for repeating a packet between the two subnetworks. In the information system 500, the application execution servers 503Aa, 503Ab, . . . , and 503Ba, 503Bb, . . . are separately connected to the two subnetworks 501A and 501B. More specifically, the application execution servers 503Aa, 503Ab, . . . are connected to the subnetwork 501A, and the application execution servers 503Ba, 503Bb, . . . are connected to the subnetwork 501B. Although not shown in FIG. 5, network monitoring servers 505A and 505B include a detector, an address list, a monitoring log, and the like as in the configuration shown in FIG. 1. A system management server is connected to the subnetworks 501A and 501B.

In this case, one or more network monitoring server 505A and one or more network monitoring server 505B may be connected to the subnetworks 501A and 501B, respectively. In FIG. 5, the network monitoring server 505A is connected to the subnetwork 501A, so that the packet monitor 121 monitors a packet from the subnetwork 501A. The network monitoring server 505B is connected to the subnetwork 501B, so that the packet monitor 121 monitors a packet from the subnetwork 501B.

In this manner, since the network monitoring server is connected to only one subnetwork, the possibility that a packet flowing in another subnetwork cannot be obtained can be prevented. Although the case in which the two subnetworks are used is described by using FIG. 5, the same effect can be obtained even though three or more subnetworks are used.

The second modification has the following function. That is, the network 101 of the information system 100 is connected to one or more network device such as switch or a router, the network device holds a list of addresses of computers packets of which are repeated by the network device, and the list is displayed by an operation command or the like.

When the network device has such a function, the network monitoring server 105 may obtain list displays of the addresses from the network device at predetermined intervals in place of the packet monitor 121 and may give the obtained list of addresses to the detector 122.

In this manner, the network monitoring server 105 need not monitor a packet flowing in the network 101 by itself, step S401 shown in FIG. 4 is not necessary, and necessary throughput can be reduced.

(Application 1)

The service business can be performed by using the network monitoring server 105 according to this embodiment. More specifically, with respect to a business organization holding the information system 100, another service trader connects a network monitoring server held by the service trader to the network 101 of the information system 100 of the business organization in place of the network monitoring server 105 held by the business organization. The network monitoring server is the same as the network monitoring server 105 described above except that the contents of the monitoring log 126 are encoded to prevent the contents from being altered. The service trader receives a charge from the business organization and certifies the contents of the monitoring log 126 of the network monitoring server to the third party different from the business organization and the service trader.

According to this service, the business organization persuasively shows to the third party that an evaluated operational risk is a result obtained by extracting loss events from all the computers used in a business application in the business organization. The service trader performs the certifying service to obtain a profit from the business organization.

(Application 2)

The following insurance business can be performed by using the method according to this embodiment. That is, an insurance company collects insurance premiums. If a corresponding business organization suffers a loss by a cause corresponding to an operational risk, the insurance company performs insurance payment depending on the loss. In this case, the insurance company executes the agents 110 in the application execution servers 103a, 103b, . . . held by the customer business organization in the information system of the customer business organization, and connects the system management server 104 and the network monitoring server 105 to the network 101.

In this manner, the insurance company can correctly evaluate an operational risk of a customer business organization. For this reason, the insurance company can exactly respond to a customer business company such that an insurance premium can be increased or decreased depending on a risk. The insurance company can increase the attraction of the insurance by showing a low insurance premium to a customer business organization having a small operational risk. The risk that the insurance company suffers a loss by insurance payment because the insurance company receives an excessively low insurance premium from a high-risk business organization can be reduced.

The present invention made by the present inventor has been described in detail on the basis of the embodiment. However, the present invention is not limited to the embodiment, and modifications and changes of the invention can be effected without departing from the spirit and scope of the invention.

Advantages obtained by typical aspects of the invention disclosed in this application will be briefly described below.

(1) An operational risk can be evaluated on the basis of loss events collected by an agent of an application execution server, and, furthermore, a record of a network monitoring server is inspected to make it possible to check whether loss events are collected from all the computers used in an application in a business organization or not.

(2) A service business which assures the third party that loss events are collected from all computers used in an application in a customer business organization, so that a profit can be obtained.

(3) An insurance company or the like applies the operational risk evaluation method to an information system of a customer business organization, so that a loss generated by an event corresponding to an operational risk of the customer business organization can be correctly evaluated. The insurance business which compensates for the loss and which determines an insurance premium on the basis of the evaluation result can be managed.

What is claimed is:

1. A network monitoring method for an information system comprising:
a first step of, in at least one first computer connected to a network and executing an application, executing at least one agent to collect an operation history in the first computer;
a second step of, in at least one second computer connected to the network and monitoring the network, monitoring and recording the presence of the first computer in which the agent is not executed; and
a third step of inspecting the record to check whether or not the agent is executed in all the first computers constituting the information system.

2. A network monitoring method for an information system according to claim 1, wherein the second step includes:
a step of monitoring a packet flowing in the network in the second computer;
a step of extracting the address of a transmission source and/or a transmission destination from the monitored packet in the second computer;
a step of transmitting a message to the agent of the first computer corresponding to the address in the second computer; and
a step of checking a response to the transmitted message in the second computer to record the address of the first computer having no response.

3. A network monitoring method for an information system according to claim 1, wherein the second step includes:
a step of communicating with a network device constituting the network in the second computer to obtain an address list of the first computer connected to the network device;
a step of transmitting a message to the agent of the first computer corresponding to an address in the obtained address list in the second computer;
a step of checking a response to the transmitted message in the second computer to record the address of the first computer having no response.

4. An operational risk evaluation method for an information system comprising:
a first step of, in at least one first computer connected to a network and executing an application, executing at least one agent to collect an operation history in the first computer;
a second step of extracting an event in which a loss is generated from the collected operation history;
a third step of determining an amount of loss in the extracted event;
a fourth step of, in at least one second computer connected to the network and monitoring the network, monitoring and recording the presence of the first computer in which the agent is not executed; and
a fifth step of inspecting the record to check whether or not the agent is executed in all the first computers constituting the information system.

5. An operational risk evaluation method for an information system according to claim 4, wherein the fourth step includes:
a step of monitoring a packet flowing in the network in the second computer;
a step of extracting the address of a transmission source and/or a transmission destination from the monitored packet in the second computer;
a step of transmitting a message to the agent of the first computer corresponding to the address in the second computer; and
a step of checking a response to the transmitted message in the second computer to record the address of the first computer having no response.

6. An operational risk evaluation method for an information system according to claim 4, wherein the fourth step includes:
a step of communicating with a network device constituting the network in the second computer to obtain an address list of the first computer connected to the network device;
a step of transmitting a message to the agent of the first computer corresponding to an address in the obtained address list in the second computer; and
a step of checking a response to the transmitted message in the second computer to record the address of the first computer having no response.

7. A method for performing a service business for certifying correctness of an operational risk of a customer business organization, comprising:
a first step of, in at least one first computer connected to a network and held by the customer business organization for executing an application, executing at least one agent to collect an operation history in the first computer;
a second step of, in at least one second computer connected to the network and provided under the management of a service trader, monitoring and recording the presence of the first computer in which the agent is not executed; and
a third step of inspecting the record to check, in the service trader, whether or not the agent is executed in all the first computers constituting the information system.

8. A method for performing a service business for certifying the correctness of an operational risk of a customer business organization according to claim 7, wherein the second step includes:
a step of monitoring a packet flowing in the network in the second computer;
a step of extracting the address of a transmission source and/or a transmission destination from the monitored packet in the second computer;
a step of transmitting a message to the agent of the first computer corresponding to the address in the second computer; and
a step of checking a response to the transmitted message in the second computer to record the address of the first computer having no response.

9. A method of managing an insurance business for compensating a loss generated by an event corresponding to an operational risk of a customer business organization, comprising:
a first step of, in at least one first computer connected to a network and held by the customer business organization for executing an application, executing at least one agent to collect an operation history in the first computer;
a second step of extracting an event in which a loss is generated from the collected operation history;
a third step of determining an amount of loss in the extracted event;
a fourth step of, in at least one second computer connected to the network and provided under the management of an insurance company, monitoring and recording the presence of the first computer in which the agent is not executed; and
a fifth step of inspecting the record to check, in the insurance company, whether or not the agent is executed in all the first computers constituting the information system.

10. A method of managing an insurance business for compensating a loss generated by an event corresponding to an operational risk of a customer business organization according to claim 9, wherein the fourth step includes:
a step of monitoring a packet flowing in the network in the second computer;
a step of extracting the address of a transmission source and/or a transmission destination from the monitored packet in the second computer;
a step of transmitting a message to the agent of the first computer corresponding to the address in the second computer; and
a step of checking a response to the transmitted message in the second computer to record the address of the first computer having no response.
